(19) United States
(12) Patent Application Publication
(10) Pub. No.: US 2026/0110608 A1
(43) Pub. Date: Apr. 23, 2026

(54) DELIVERY SYSTEM FOR FUSION DEVICE

(71) Applicant: SPECTRIS CANADA INC., Quebec (CA)

(72) Inventors: Pierre BOUCHARD, St-Laurent (CA); Julien BOISCLAIR, St-Laurent (CA)

(21) Appl. No.: 19/154,610

(22) PCT Filed: Feb. 8, 2024
(86) PCT No.: PCT/CA2024/050163

§ 371 Date: Aug. 7, 2025

Related U.S. Application Data
(60) Provisional application No. 63/483,794, filed on Feb. 8, 2023.

(51) Int. Cl. G01N 1/44; G01N 23/2202

(52) U.S. Cl. CPC G01N 1/44; G01N 23/2202

(57) ABSTRACT

A method of operating a delivery system for a fusion system having a fusion area and pill delivery paths in communication with the fusion area, the method includes: with a delivery mechanism, at a first position, receiving pills to be distributed, the first position forwardly offset from the pill delivery paths; moving the delivery mechanism rearwardly from the first position to a second position, the second position above the pill delivery paths; and with the delivery mechanism, at the second position, dropping the pills into the fusion area along the pill delivery paths.

### CROSS-REFERENCE TO RELATED APPLICATIONS

This International PCT application claims priority on U.S. Provisional Application No. 63/483,794 filed Feb. 8, 2023.

### TECHNICAL FIELD

The application relates generally to the field of analytical sample preparation, and more particularly, to the field of analytical sample preparation by fusion.

### BACKGROUND

High quality and productive sample preparation can be key for chemical analysis of samples using X-Ray Fluorescence Spectrometry (XRF), Inductively Coupled Plasma Optical Emission Spectroscopy (ICP-OES), Inductively Coupled Plasma Mass Spectrometry (ICP-MS) and Atomic Absorption Spectroscopy (AAS). Whichever samples are being assessed (e.g. loose or pressed powders, glass disks, solid samples, or liquid solutions), finding the right approach to sample preparation is the first, and often the most important step in achieving accurate and reproducible results.

Fusion process sample preparation can involve heating up the chemical compound to melt the sample/flux, and then cooling down the melt to solidify the sample. In a typical fusion system, the mechanism that holds the sample crucible moves the sample from a heating zone to a cooling zone, and holds the sample crucible during the heating. Since process temperatures can be quite high, various problems and challenges can arise, such as contamination of the sample, health & safety concerns for operators, challenges and costs associated to selecting materials operable to sustain high temperatures which can be present at the fusion area, and thermal inertia of components which may interfere with or slow the reaching of an intended thermal state. Moreover, the fusion process can be a bottleneck in a sample analysis process, and therefore, productivity can be a significant additional concern. There always remains room for improvement.

### SUMMARY

In one aspect, there is provided a method of operating a delivery system for a fusion system having a fusion area and pill delivery paths in communication with the fusion area, the method comprising: with a delivery mechanism, at a first position, receiving pills to be distributed, the first position forwardly offset from the pill delivery paths; moving the delivery mechanism rearwardly from the first position to a second position, the second position above the pill delivery paths; and with the delivery mechanism, at the second position, dropping the pills into the fusion area along the pill delivery paths.

In some embodiments, the receiving of the pills includes receiving the pills within moving plate apertures of a moving plate.

In some embodiments, the method includes moving the moving plate and the pills located within the moving plate apertures from a receiving position in which the moving plate apertures are offset from distributing apertures of a distributing plate to a distributing position in which the moving plate apertures are aligned with the distributing apertures and in which the pills move from the moving plate apertures to the distributing apertures.

In some embodiments, the method includes receiving the pills into a carrier from the distributing apertures.

In some embodiments, the method includes guiding the pills into the moving plate apertures with a hopper plate having hopper apertures.

In some embodiments, the moving of the pills from the first position to the second position includes receiving the pills into a carrier.

In some embodiments, the method includes moving the carrier from the first position to the second position.

In some embodiments, the moving of the pills from the first position to the second position includes moving the carrier containing the pills from the first position to the second position.

In some embodiments, the carrier defines first apertures, the method comprising moving a carrier movable plate relative to the carrier from a first relative position in which the first apertures of the carrier are offset from apertures of the carrier movable plate and a second relative position in which the first apertures are in alignment with the apertures of the carrier movable plate.

In some embodiments, the moving of the carrier from the first positing to the second position includes abutting the carrier movable plate against a tab to move the carrier movable plate relative to the carrier until the first apertures (of the carrier) are aligned with the apertures of the carrier movable plate.

In another aspect, there is provided a delivery system for a fusion system having a fusion area and pill delivery paths leading to the fusion area, the delivery system comprising: a frame; a dispensing mechanism mounted to the frame, the dispensing mechanism operable to receive pills and to distribute the pills; and a delivery mechanism movable between a first position in which the delivery mechanism is adjacent the dispensing mechanism for receiving the pills from the dispensing mechanism and a second position in which the delivery mechanism is adjacent the pill delivery paths to deliver the pills to the pill delivery paths.

In some embodiments, the dispensing mechanism includes: a hopper plate defining hopper apertures; a moving plate defining moving plate apertures; and a distributing plate defining distributing apertures, wherein the hopper apertures are offset from the distributing apertures, the moving plate moving between a receiving position in which the moving plate apertures are in alignment with the hopper apertures and a dispensing position in which the moving plate apertures are in alignment with the distributing apertures.

In some embodiments, an actuator is engaged to the moving plate to move the moving plate between the receiving position and the dispensing position, the actuator drivingly engaged to a threaded shank threadingly engaged to a nut secured to the moving plate.

In some embodiments, the delivery mechanism includes: a carrier moving relative to the frame, the carrier defining first apertures; an actuator engaged to the carrier and the frame, the actuator operable to move the carrier between the first and second positions; and a carrier movable plate defining apertures, wherein the carrier movable plate is movable relative to the carrier between a first relative position in which the first apertures are offset from the apertures of the carrier movable plate and a second relative position in which the first apertures are in alignment with the apertures of the carrier movable plate.

In some embodiments, the carrier defines second apertures, the carrier movable plate movable relative to the carrier into a third relative position in which the second apertures are in alignment with the apertures of the carrier movable plate.

In some embodiments, a first tab is secured to the frame, the first tab in abutment against the carrier movable plate to move the carrier movable plate from the first relative position to the second relative position when the delivery mechanism is in the second position.

In some embodiments, a second tab is secured to the frame, the second tab in abutment against the carrier movable plate to move the carrier movable plate from the second relative position to the first relative position when the delivery mechanism is in the first position.

In some embodiments, the carrier movable plate defines a V-notch, the first tab received within the V-notch for aligning the carrier movable plate in the second position of the delivery mechanism, the carrier movable plate movable transversally relative to a direction of travel of the carrier between the first and second positions.

In yet another aspect, there is provided a dispensing mechanism for a delivery system of a fusion system, comprising: a hopper plate defining hopper apertures; a moving plate defining moving plate apertures; and a distributing plate defining distributing apertures, wherein the hopper apertures are offset from the distributing apertures, the moving plate moving between a receiving position in which the moving plate apertures are in alignment with the hopper apertures and a dispensing position in which the moving plate apertures are in alignment with the distributing apertures.

In some embodiments, an actuator is engaged to the moving plate to move the moving plate between the receiving position and the dispensing position.

In yet another aspect, there is provided a delivery mechanism for a delivery system of a fusion system, comprising: a carrier moving in relationship to a frame, the carrier defining first apertures; an actuator engaged to the carrier and the frame, the actuator operable to move the carrier between a first position and a second position; and a carrier movable plate defining apertures, wherein the carrier movable plate is movable relative to the carrier between a first relative position in which the first apertures (of the carrier) are offset from the apertures of the carrier movable plate and a second relative position in which the first apertures (of the carrier) are in alignment with the apertures of the carrier movable plate.

In some embodiments, the carrier defines second apertures, and the carrier movable plate is movable relative to the carrier into a third relative position in which the second apertures are in alignment with the apertures of the carrier movable plate.

In some embodiments, a first tab is secured to the frame, the first tab in abutment against the carrier movable plate to move the carrier movable plate from the first relative position to the second relative position when the delivery mechanism is in the second position.

In some embodiments, a second tab is secured to the frame, the second tab in abutment against the carrier movable plate to move the carrier movable plate from the second relative position to the first relative position when the delivery mechanism is in the first position.

In some embodiments, the carrier movable plate may define a V-notch, the first tab being received within the V-notch for aligning the carrier movable plate, the carrier movable plate movable transversally relative to a direction of travel of the carrier between the first and second positions.

In another aspect, there is provided a method for dispensing pills for a fusion system, comprising: receiving the pills within moving plate apertures of a moving plate; moving the moving plate and the pills located within the moving plate apertures from a receiving position in which the moving plate apertures are offset from distributing apertures of a distributing plate to a distributing position in which the moving plate apertures are aligned with the distributing apertures; and receiving the pills from the moving plate apertures into the distributing apertures.

In some embodiments, the method includes guiding the pills into the moving plate apertures with hopper apertures of a hopper plate.

In some embodiments, the moving of the moving plate and the pills includes powering an actuator engaged to the moving plate, the actuator drivingly engaged to a threaded shank threadingly engaged to a nut secured to the moving plate.

In another aspect, there is provided a method for delivering pills into a fusion area of a fusion system via pill delivery paths, comprising: receiving the pills within a carrier; moving the carrier containing the pills from a first position in which the carrier is offset from the pill delivery paths to a second position; and dropping the pills in to the pill delivery paths.

In some embodiments, the moving of the carrier from the first position to the second position includes powering an actuator engaged to a threaded shank threadingly engaged to a nut secured to the carrier.

In some embodiments, the dropping of the pills includes moving a carrier movable plate relative to the carrier until apertures of the carrier movable plate are aligned with apertures of the carrier to allow the pills to pass through the apertures of both the carrier movable plate and the carrier.

In some embodiments, the moving of the carrier movable plate relative to the carrier includes abutting the carrier movable plate against a tab thereby pushing on the carrier movable plate to move the carrier movable plate relative to the carrier.

### BRIEF DESCRIPTION OF THE DRAWINGS

Reference is now made to the accompanying figures in which:

FIG. 1A is a perspective view of a fusion system;

FIG. 1B is a perspective view showing internal components of the fusion system of FIG. 1A;

FIG. 1C is a cross-sectional view of a portion of the fusion system of FIG. 1A;

FIG. 1D is another a cross-sectional view of a portion of the fusion system of FIG. 1A;

FIG. 1E is an example of a controller of the fusion system of FIGS. 1A and 1B;

FIG. 2 is an oblique view of a delivery system in accordance with one embodiment for the fusion system of FIG. 1A;

FIG. 3 is another oblique view of the delivery system of FIG. 2;

FIG. 4 is a partially exploded oblique view of a dispensing mechanism for the delivery system of FIG. 2;

FIG. 5 is an oblique cross-sectional cutaway view taken along line 5-5 on FIG. 7;

FIG. 6 is a cross-sectional view of the distributer assembly of FIG. 4 taken along line 6-6 on FIG. 4;

FIG. 7 is another cross-sectional view of the distributer assembly of FIG. 4 taken along line 6-6 on FIG. 4;

FIG. 8 is an enlarged view of a portion of FIG. 7 illustrating a first position of a moving plate;

FIG. 9 is another enlarged view of the portion of FIG. 7 illustrating a second position of the moving plate;

FIG. 10 is an enlarged view of the portion of FIG. 7 illustrating the distributer assembly in accordance with another embodiment;

FIG. 11 is an enlarged view of the portion of FIG. 7 illustrating the distributer assembly in accordance with another embodiment;

FIG. 12 is a top view of a movable plate in accordance with the embodiment of FIG. 11;

FIG. 13 is an oblique view of a carrier of the delivery system of FIG. 2;

FIG. 14 is a bottom view of the carrier of FIG. 13;

FIGS. 15A to 15C are top views of the carrier of FIG. 13 shown in three different configurations;

FIG. 16 is a top oblique view of a portion of the carrier of FIG. 13 illustrating a self-centering feature of the carrier;

FIG. 17 is a top oblique view of another portion of the carrier of FIG. 13 illustrating a fastening system thereof;

FIG. 18 is a cross-sectional cutaway view illustrating the fastening system; and

FIG. 19 is a bottom view of the carrier illustrating another portion of the fastening system.

### DETAILED DESCRIPTION

A fusion system for the preparation of inorganic analytical samples (or mineral analytical samples) is disclosed. The fusion system includes a furnace operable to receive containers such as crucibles therein for heating the contents of the containers in order to prepare a fused mixture for analysis. An inorganic sample is solubilized in a fused flux to obtain a fused mixture (also referred to as a sample herein, or as a fused sample) suitable to prepare analytical samples. The analytical sample can be a glass disk for X-ray fluorescence (XRF) analysis, a solution for inductively coupled plasma (ICP) analysis or a solution for atomic absorption (AA) analysis, to name some examples.

In one embodiment, the fusion system can include a furnace having heating element(s), and a sample holder operable to support a plurality of containers such as crucibles in which the fused mixture can be generated. Once fused, different approaches can exist depending on the application. In one embodiment, the sample can stay in the crucible (e.g. mouldable or peroxide application). In another embodiment, the samples can be transferred from the crucibles to other containers prior to cooling, and the analytical samples thereby obtained can be operable to sustain subsequent analysis. Such other containers can be moulds in the case of XRF analysis to obtain glass disks, or beakers containing an acidic solution for ICP and/or AA analysis, to name some examples. In some embodiments, it can be desired for such other containers to be subjected to the same temperature conditions as the samples during the fusion process.

It should be understood that, as used herein, the expressions “fuse”, “fusing”, “fusion”, or any other equivalent expression, refers to the process of dissolving material into flux in order to prepare a homogeneous, or near-homogeneous, mixture. It should also be understood that the material being fused generally includes a fusion flux compound or a mixture of several fusion flux compounds, such that the material to be analyzed can be solubilized upon fusion of the flux material.

In some embodiments, the flux material is a borate compound. In such case, the process may be referred to as a “borate fusion” process. It should be understood that the borate fusion process can include various steps that can be implemented using the fusion system. In a non limiting example, the borate fusion process can include the following steps:
(a) mixing of an inorganic analytical sample with a borate flux (typically lithium-based and/or sodium-based), collectively referred to as a sample, in a crucible (for example a Pt crucible or a Pt—Au crucible);
(b) heating the mixture in the crucible to a temperature between 800° C. and 1300° C., or between 1000° C. and 1200° C., or between 1000° C. and 1100° C., or at about 1050° C., with agitation until the borate flux melts and the inorganic sample dissolves homogeneously into the fused borate flux. It should be understood that the temperature can be selected based on the type of flux material and/or the nature of the sample to be analyzed. The mixture thereby obtained can be referred to as a “fused mixture” or “fused sample”; and
(c) optionally pouring the fused samples from the crucible into a mould.

Commonly-used borate flux materials may be selected from the group consisting of lithium tetraborate (Li₂B₄O₇), lithium metaborate (LiBO₂), sodium tetraborate (Na₂B₄O₇) and combinations thereof, however it will be appreciated that other flux materials could be used and the present disclosure is not limited to the use of the flux materials specifically identified herein. The choice of flux material typically depends on the composition of the sample to be analyzed.

Additives can optionally be added to the flux material to modify their properties or to help oxidize partially oxidized elements that can be present in a sample to be analyzed. Non-limiting examples of additives that can be added include the following:
(a) absorbers such as La₂O₃, BaO₂ or SrO can optionally be added to decrease the matrix effect by increasing X-ray absorption of the flux;
(b) fluidizers such as LiF can optionally be added for potentially better transfer of the fused mixture into the mould when preparing an analytical sample for XRF analysis;
(c) internal standards such as various oxides can optionally be added if required in the analytical technique chosen;
(d) oxidizing agents such as NH₄NO₃, NaNO₃, KNO₃, LiNO₃ or Sr(NO₃)₂ can optionally be added to oxidize non-oxidized and/or partially-oxidized inorganic compounds that may be present in the sample to be analyzed; and/or
(e) non-wetting agents such as NaBr, LiBr, KI, CsI, NH₄I or LiI can optionally be added to reduce stickiness to the labware (e.g., crucible, mold, other container) and facilitate casting.

When oxidizers are used, it may be desirable to pre-heat the flux material/oxidizer/sample mixture to an oxidizing temperature (also referred to herein as a “pre-heating temperature”) that is lower than the fusion temperature and at which oxidizing of the non-oxidized and/or partially-oxidized inorganic elements can occur. For example, in the case of borate flux materials, the oxidizing (or pre-heating) temperature can be set between 150° C. and 1000° C.

For example, when ammonium nitrate is used, the pre-heating of the flux material/oxidizer/sample mixture can be performed at a temperature that decomposes the ammonium nitrate into NO₂ and HNO₃. At least one of these gases can then oxidize the non-oxidized and/or partially-oxidized inorganic elements present in the mixture.

In some embodiments, it can be desirable that a slow decomposition of the oxidizer occurs, as a slow decomposition typically allows for a longer action of the oxidizer on the non-oxidized and/or partially-oxidized inorganic elements present in the mixture. A “slow decomposition” can for example be triggered by first subjecting the flux material/oxidizer/sample mixture to a first temperature that is lower than the temperature of the main fusion step in the heating chamber. The decomposition of the oxidizer can then occur slower at the first temperature than if it had occurred directly at the fusion temperature. Subsequent oxidizing action on the non-oxidized and/or partially-oxidized inorganic elements are prolonged when performed at the first temperature compared to instances where the flux material/oxidizer/sample mixture is directly subjected to the fusion temperature.

It should also be understood that other types of flux materials can be used, such as a peroxide flux material (for example, sodium peroxide Na₂O₂). In such case, the mixture in the crucible can be heated between 450° C. and 650° C. with agitation until the peroxide flux melts and the inorganic analytical sample dissolves homogeneously in the fused peroxide flux.

In some embodiments, the material to be analyzed can include various inorganic materials (also referred to as mineral materials). Non-limiting examples of inorganic materials that can be subjected to the borate fusion process include cement, lime, carbonate, ceramic, glass, slag, refractory material, mining and geological materials, silicate, clay, ores, sulfides, fluorides, bauxite, aluminum, metal-based catalysts, steel, metals, ferroalloys, non-ferrous alloys and mineral/inorganic impurities contained in organic compounds such as polymers or pharmaceutical products.

In the present disclosure, preparing an analytical sample may include the steps of mixing an inorganic sample with a flux material, heating the mixture until the flux material melts and the inorganic sample dissolves into the fused flux material to obtain a fused mixture (sample). Non-limiting examples of “flux fusion” include the “borate fusion” and the “peroxide fusion” examples evoked above.

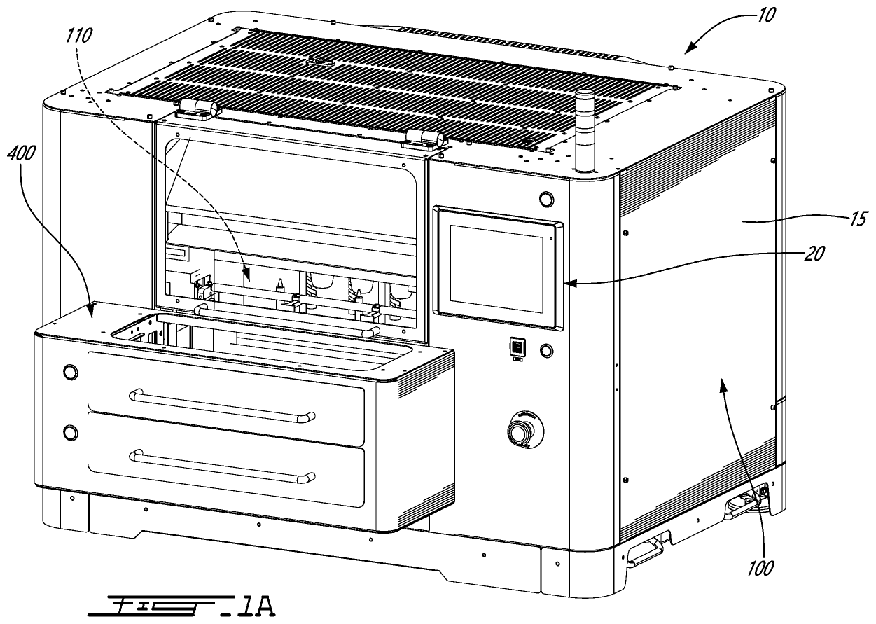

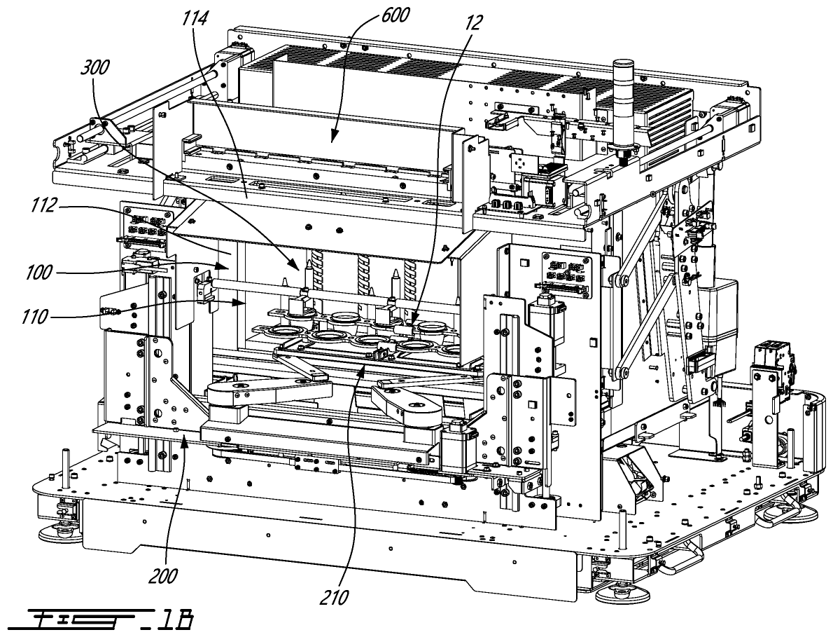

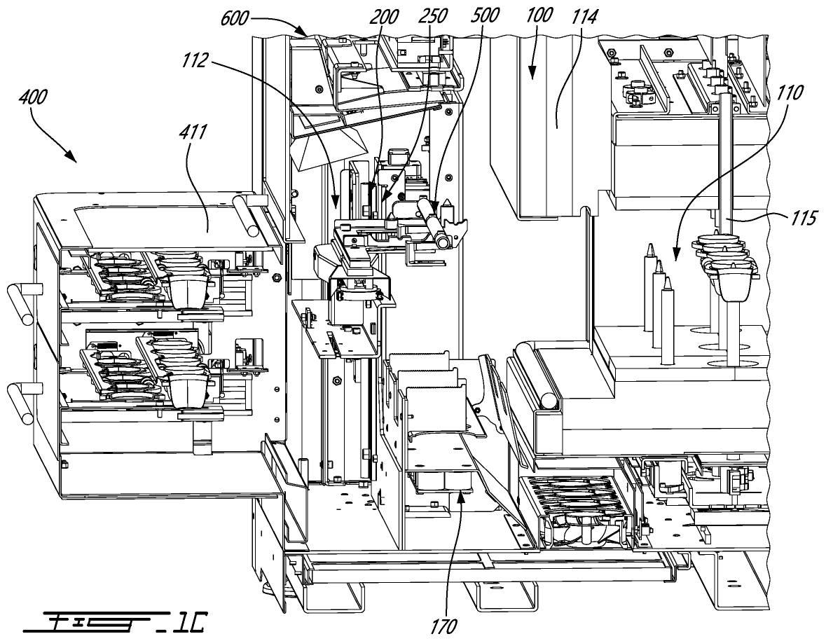

Referring now to FIGS. 1A-1E, an example of a fusion system 10 is depicted including a furnace 100 for generating heat.

The furnace 100 includes a heating chamber 110 provided with heating element(s) 120 (seen in FIG. 1D). The heating chamber 110 is an internal volume of the furnace 100 that is delimited by heating chamber walls 112. In the illustrated embodiment, the heating chamber walls 112 are interconnected at right angles to form a single, cube-shaped heating chamber 110. Other arrangements of the heating chamber walls 112 are possible, and thus so are other shapes for the heating chamber 110. In the illustrated embodiment, one of the heating chamber walls 112 has a door 114. The door 114 can open and close relative a doorway, preferably in a fully or partially automated manner, to provide selective access to the heating chamber 110 through the doorway, as described in greater detail below. The door 114 can be maintained in a closed state during agitating and fusing. The door may include a transparent or translucent section, such as a window, to provide visual access to the heating chamber and allow a person to view the fusion process. In the illustrated embodiment, the heating chamber wall 112 formed by the door 114 is the only heating chamber wall movable portion, the other heating chamber walls remaining fixed relative to one another throughout operation. In this embodiment, the door 114 is a sliding body which translates in the vertical direction to expose the heating chamber 110 and to close it to thereby help thermally insulate or isolate the heating chamber 110 from the environment outside of the furnace 100 during the heating step. Other configurations of the door 114 are possible. For example, the door may open and close by pivoting relative to a hinge, or the door may translate in a generally horizontal direction (in the example embodiment, the movement is slightly oblique from horizontal). In a production environment, available space may be limited or costly, and in some embodiments, using a sliding door rather than a hinged door may help limiting the footprint of the equipment.

In some embodiments, the heating chamber walls and door may be omitted, and the fusion area may not be enclosed within heating chamber walls. For instance, if the heating elements are in the form of fuel nozzles and operate via combustion, the heat may be sufficiently localized onto the crucibles to avoid the necessity of enclosing the crucibles in walls during the fusion operation, and the fusion area may be in the vicinity of such fuel nozzles.

It has been observed, for instance, that putting the samples into the heating chamber 110 can cause the temperature of the heating chamber 110 to temporarily decrease, which can be associated to the need of returning the temperature to the desired temperature for fusion, such that it may be desirable to quickly reach the desired temperature in order to quickly begin the oxidation process. Different factors have an impact on the time it may take to return to the temperature set-point including power delivery in the heating chamber 110 as well as heat loss. The mass of material inserted into the heating chamber 110 may also have an impact on time required to return to the temperature set-point, and/or simply on the overall amount of time required to achieve a given temperature of the samples. The minimal mass that needs to be placed in the heating chamber 110 is the containers (e.g. crucibles) in which the samples (e.g. including flux) are contained, and any support or holder for the containers. In some cases, the samples may be transferred into other containers (e.g. mould, beaker) after fusion, and it can be required to heat such other containers to the same temperature and therefore move it into and out from the heating furnace together with the samples. Accordingly, the minimal mass may further include such other containers and any support or holder therefore. Another factor that may have an impact on returning to or otherwise achieving the temperature set-point is heat loss through/via any opening across heating chamber walls, such as an opening 116 through which the containers are inserted and subsequently received, as described in greater detail below. Other openings in the heating chamber walls 112 may be needed for different reasons including managing the chemical fumes produced during the fusion process, to insert the heating element(s) 120, and more. All these openings may have an impact on the temperature distribution/uniformity inside the heating chamber 110 and therefore may have an impact on the heat transfer to the samples.

In order to minimise heat loss and help achieve uniform temperature distribution within the heating chamber 110, it may be desirable for the putting and removing of the samples into/from the heating chamber 110 to be performed relatively quickly. Performing these operations in a fully or partially automated manner may be helpful in consistently achieving satisfactory loading (and/or unloading) times.

In this specific example, the fusion system has a particular combination of a plurality of features including a handling mechanism 200 (seen in FIGS. 1B and 1C), an agitation mechanism 300 (see in FIG. 1D), a sample holder 12 (seen in FIG. 1B), a pouring mechanism 500 (seen in FIG. 1C), a multiple loading mechanism 400 (seen in FIG. 1A), and a delivery system 600 (seen in FIGS. 1B and 1C) that is used to load the pills into the heating chamber 110. In this example, all these mechanisms, together with the heating chamber, are enclosed in an outer housing 15, seen in FIG. 1A, which may be useful both for health and safety reasons and for giving the system an agreeable finished appearance for instance. Different embodiments can have one or some of these features in any suitable sub-combination.

In this example, the handling mechanism 200 can have a support 220 operable to carry one or more sample holder 12 (FIG. 1C) as the handling mechanism 200 moves the sample holder(s) 12 throughout different steps of the fusion process.

In this example, one (or more) sample holder 12 is provided in the form of a component distinct from both the handling mechanism 200 and the agitation mechanism 300. The sample holder 12 can have a plurality of containers which can be either separable from or integrated with the sample holder. In some embodiments, more than one sample holder 12 can be provided, such as a first sample holder 12 in which the containers are crucibles and a second sample holder in which the containers are moulds or beakers. More specifically, the sample holder(s) 12, the handling mechanism 200, and the agitation mechanism 300 can be operable for the handling mechanism 200 to carry the sample holder(s) via a support as it moves the sample holder(s) into the furnace 100, while a door of the furnace is open, for the handling mechanism 200 to engage the sample holder 12 with the agitation mechanism 300 and to then move the support 210 out from the furnace 100, without the sample holder 12, after which the door can close. At this point, the agitation mechanism 300 can agitate the sample holder 12, with the samples contained therein, during the fusion process. Subsequently to the fusion process, the handling mechanism 200 can move the support back into the furnace, disengage the sample holder from the agitation mechanism 300, and move the sample holder 12 out from the furnace.

Moreover, in this embodiment, the handling mechanism 200 can further be operable to move a first sample holder 12 having the samples into engagement with a pouring mechanism 500, and then disengage from the first sample holder 12. A second sample holder having moulds or beakers can also be provided. The pouring mechanism 500 can then pour the samples into the moulds by pivoting the first sample holder 12 around a horizontal axis. The handling mechanism 200 can then remove the first sample holder 12 from the pouring mechanism 500.

The handling mechanism 200 can move the samples to an optional, dedicated cooling station 170 to expose the samples to a stream of cool air to accelerate cooling.

Moreover, in this embodiment, the multiple loading mechanism 400 can have two or more loading stations for sample holders, and the handling mechanism 200 can be operable to allow to selectively put or remove one or more sample holders from either one of the loading stations in a manner that the loading stations can be loaded or unloaded independently from one another. Indeed, the step of putting the sample holder into a loading area, directly onto the support of the handling mechanism, or putting samples into a sample holder which is in a loading area or supported by a handling mechanism, can be referred to herein as “loading” and the step of removing the sample holder from a loading station, from the support, or of removing solid samples from a sample holder which is in a loading station or on a support, can be referred to herein as “unloading”.

It will be noted that in some embodiments of fusion processes, agents, such as a non-wetting agent for instance, are introduced to assist with the fusion process in one way or another. In some cases, introducing such an agent into the sample at the beginning of a fusion cycle may not be suitable. Indeed, in the case of non-wetting agents for instance, incorporating the non-wetting agent at the beginning of the fusion process may lead to premature evaporation of the non-wetting agent, and a loss of efficiency. In some embodiments, it can be convenient to provide one or more of such agents in the form of small tablets commonly referred to in the art as “pills”, and to introduce the pills into the samples at an intermediary point in time in the fusion cycle. Indeed, the pills can be introduced into the fusion area via pill delivery paths. The pill delivery paths can be defined by tubular conduits, which can be referred to as “chimneys”, which extend across an upper wall of a heating chamber, when the fusion area is enclosed in a heating chamber. One way of introducing the pills into the pill delivery paths is to drop them manually.

Several inconveniences or disadvantages may be associated to the manual handling of pills relative the pill delivery paths. In particular, the fusion system may be bulky and it may be inconvenient or uncomfortable, especially for smaller persons, to manually move the pills to the pill delivery paths. There is also a risk of error in either the number of pills dropped in corresponding ones of the pill delivery paths, or the timing at which pills are dropped in the pill delivery paths. One additional potential drawback with such agents is that binders used in the pills may have a fusion temperature and, if placed in a hot area, may melt or otherwise deteriorate prior to injection. Depending on the sample type, even if injected later during the fusion process, a lot of non-wetting agent may be needed, so it may be required to inject three pills per crucible for instance, which, in a multiple container instrument (e.g. 4, 6, or more crucibles per cycle), may present a relatively high risk of manipulation error. The timing of the injection of those pills and the accurate injection of those pills may be important for them to achieve their desired effects.

In the illustrated embodiment, the fusion system 10 includes a delivery system 600 which can be used to load the pills into the fusion area in a manner which can address or alleviate at least some of the inconveniences highlighted above.

It will be understood that any or all of these features, as well as functions associated to the operation of the furnace itself such as the opening and closing of the furnace door and/or activation and deactivation of heating elements, for instance, can include hardware operable to be controlled in a fully or partially automated manner. To this end, the fusion system 10 can have hardware which will be referred herein as a controller 20. The controller 20 can be operable to perform functions in a partially or fully automated manner. The controller can include a computer, i.e. in the form of a combination of hardware and software elements, or more purely in the form of hardware elements such as electronics. For example, hardware can include logic gates included as part of a silicon chip of the processor. Software can be in the form of data such as computer-readable instructions stored in the memory system. Alternately, hardware can be based more mainly on solid state electronic elements. It will be understood that the expression computer as used herein is not to be interpreted in a limiting manner. It is rather used in a broad sense to generally refer to the combination of some form of one or more processing units and some form of non-transitory memory system accessible by the processing unit(s). The use of the expression computer in its singular form as used herein includes within its scope the combination of two or more computers working communicatively coupled in a manner to collaborate to perform a given function. Moreover, the expression “computer” as used herein includes within its scope the use of partial capacities of a processing unit of an elaborate computing system also operable to perform other functions. Similarly, the expression “controller” as used herein is not to be interpreted in a limiting manner but rather in a general sense of a device, or of a system having more than one device, performing the function(s) of controlling one or more devices.

In the specific example embodiment presented in FIG. 1A, the controller 20 can include a computer 180 such as shown in FIG. 1E, having a processor 182 and a non-transitory memory 184 with functions defined in the form of software instructions 186 stored in the non-transitory memory. The controller 20 can further include a plurality of I/O interfaces 188 such as wired or wireless connections to a display screen, a touchpad or touchscreen, a keypad, a wired or wireless communications module, and a visual or audible alarm unit, to name a few examples.

A controller 20 can be used to control, and fully or partially automate, various phases of the overall process or cycle associated with fusion of the samples for various reasons, such as safety, or productivity. Indeed, each phase of the process, whether putting the samples onto the handling mechanism 200, putting the samples onto the agitation mechanism 300, performing the fusion, removing the samples after the fusion, pouring the fused mixture from crucibles into moulds, and/or cooling the samples, for instance, can take a certain amount of time which can cumulatively add up in defining an overall cycle duration, and reducing cycle duration can be a significant factor in increasing the productivity of a given fusion system.

Depending on the embodiment, the automated or semi-automated movement of hardware components can be based on feedback from one or more sensors, for instance (e.g. servomotor, proximity sensors), or can be automated based on prior calibration, to name some examples. In some embodiments, the controller 20 can have a function to trigger an alarm based on an indication received from one or more sensor, which can be based on conditions defined in a set of instructions stored in the non-transitory memory of the controller for instance (e.g. handling mechanism is blocked, or has not reached a given intended position). Such an alarm can be in the form of a visual and/or audible indicator, e.g. trigger the activation of a graphical user interface element on the display screen, or trigger a given level of alarm on a light tower indicator 22, such as an orange or red light alarm for instance.

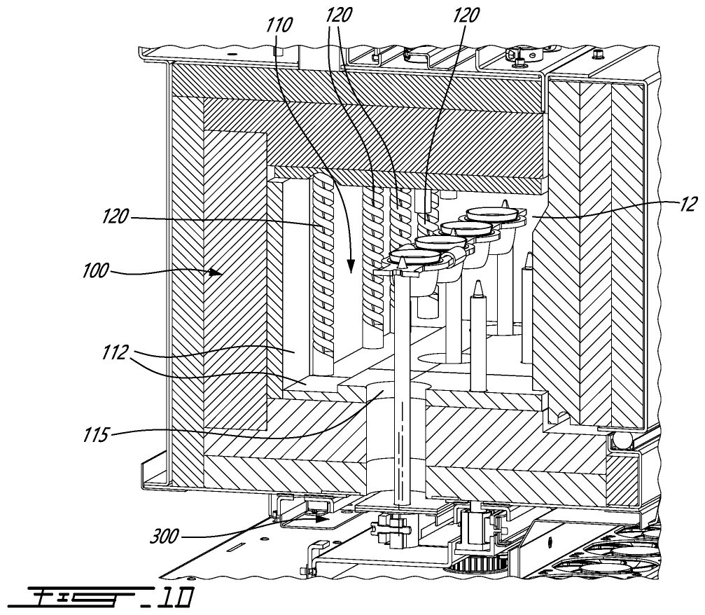

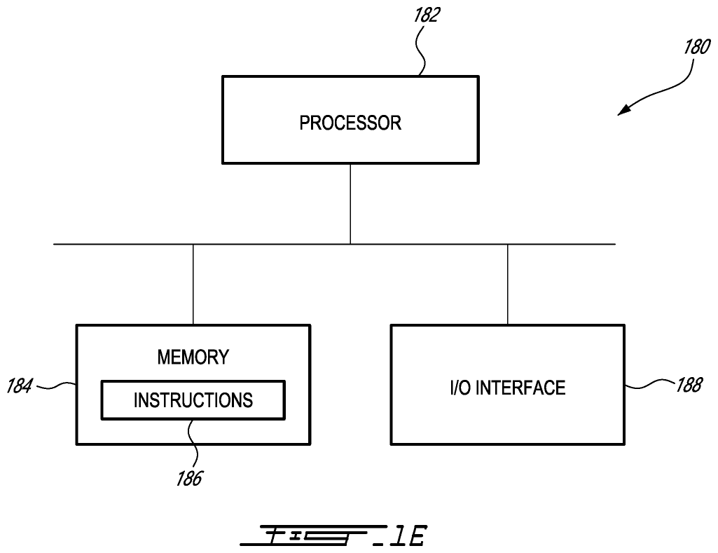

Referring now to FIGS. 2-3, the example embodiment of a delivery system 600 is shown in greater detail. The delivery system 600 is secured to the fusion system 10 via any suitable fastening means. In the embodiment shown, the delivery system 600 includes a dispensing mechanism 610 that is used for receiving the pills, e.g. from an operator; and a delivery mechanism 650 that receives the pills from the dispensing mechanism 610 and that moves the pills and delivers the pills into the pill delivery paths 115, which lead to the fusion area. More specifically, the dispensing mechanism 610 can move between a first position and a second position. The first position can be forwardly offset from the second position, where an operator can more easily reach and/or remain away from the heat, and the second position can be above the pill delivery paths. These two mechanisms are described herein below one after the other. It will be understood that the controller 20 can also be operatively connected to the delivery system 600 to control its operation and to load the pills into the heating chamber 110 when required.

The delivery system 600 includes a frame 601 that is used to hold the dispensing mechanism 610 and the delivery mechanism 650. The frame 601 has a front end 602 and a rear end 603. The front end 602 faces the operator. Hence, the front end 602 can be conveniently accessible to the operator of the fusion system 10 for loading the pills when required. In the embodiment illustrated, the front end can be associated to a location of a door of the heating chamber, and the expression forwardly and rearwardly can be used to refer to horizontally closer to the position of the door of the heating chamber or horizontally closer to the position of the rear wall of the heating chamber, for instance. The expressions forwardly and rearwardly can also apply to an embodiment where the fusion area is open rather than enclosed, to refer to closer to or farther away from an expectable position of a user. The frame 601 has two longitudinal members 604 extending from the front end 602 to the rear end 603 and two transverse members 605 extending transversally to the longitudinal members 604. Each of the two transverse members 605 interconnect respective front and rear ends of the two longitudinal members 604. The frame 601 has therefore a substantially rectangular shape, but any other suitable shapes are contemplated.

Referring to FIGS. 2-5, the dispensing mechanism 610 is described in greater detail. The dispensing mechanism 610 includes an actuator 611 operatively connected to a pill distributer 612. The pill distributer 612 is operable to receive the pills and to distribute them to the delivery mechanism 650 that will be described below.

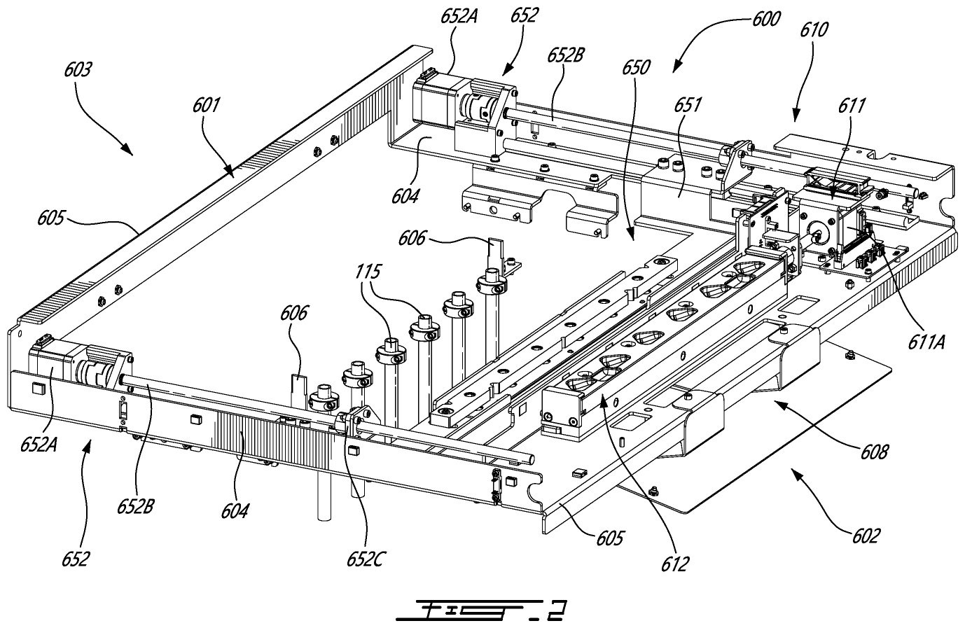

Referring more particularly to FIGS. 4-5, the pill distributer 612 includes a hopper plate 613 and a distributer assembly 614. The hopper plate 613 is shown detached from the distributer assembly 614 in FIG. 4. As shown in FIG. 4, the hopper plate 613 defines a plurality of hoppers 613A that are transversally distributed along a length of the hopper plate 613. Each of these hoppers 613A may be defined by a cavity defined by the hopper plate 613 and includes a depth that increases towards a hopper aperture 613B sized for accepting the pills (as shown in FIG. 5). The hoppers 613A may have a profile that narrows towards the hopper apertures 613B for guiding the pills towards the hopper apertures 613B. Many suitable shapes of the hoppers 613A are contemplated.

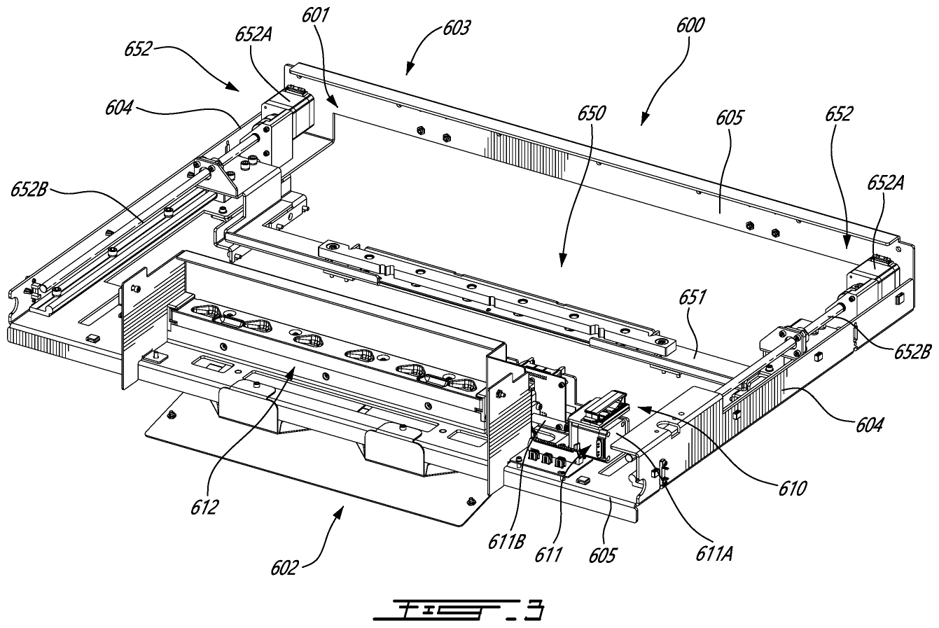

Referring more particularly to FIGS. 6-7 with continued reference to FIGS. 4-5, the distributer assembly 614 of the pill distributer 612 may include a guiding plate 615, a moving plate 616, and a distributing plate 617. The moving plate 616 is disposed between the guiding plate 615 and the distributing plate 617. In the embodiment shown, an intermediary plate 618 is disposed between the hopper plate 613 and the guiding plate 615. This intermediary plate 618 may be omitted in some embodiments. The guiding plate 615 has apertures which can be referred to as guiding apertures 615A, the moving plate 616 has apertures which can be referred to as moving plate apertures 616A, and the distributing plate 617 has apertures which can be referred to as distributing apertures 617A. The guiding apertures 615A are in alignment with the hopper apertures 613B. The distributing apertures 617A are offset from the guiding apertures 615A. The moving plate apertures 616A are movable with the moving plate 616 between a first position in which they are in alignment with the guiding apertures 615A and a second position in which they are in alignment with the distributing apertures 617A.

Referring to FIGS. 2-3 and 6, the moving plate 616 is engaged by the actuator 611 (FIG. 2). More specifically, and in the embodiment shown, the actuator 611 includes a motor 611A (FIG. 3) drivingly engaging a threaded shank 611B (FIG. 3) that is threadingly engaged to a nut 611C (FIG. 6) secured to the moving plate 616. The nut 611C may be secured to a flange 611D (FIG. 6) secured to the moving plate 616; the flange 611D extending generally transversally to the moving plate 616. Powering of the motor 611A induces rotation of the threaded shank 611B that translates into a movement of the nut 611C, and of the moving plate 616, along the direction A1 (FIG. 7). The nut may be replaced by a threaded aperture defined through the flange 611D. Any other actuators operable to move the moving plate 616 relative to the other plates are contemplated. For instance, a hydraulic or pneumatic actuator may be used, an electric motor or a solenoid may be used, and so on. The actuator 611 is operable to move the moving plate 616 along a direction depicted by arrow A1 in FIG. 7.

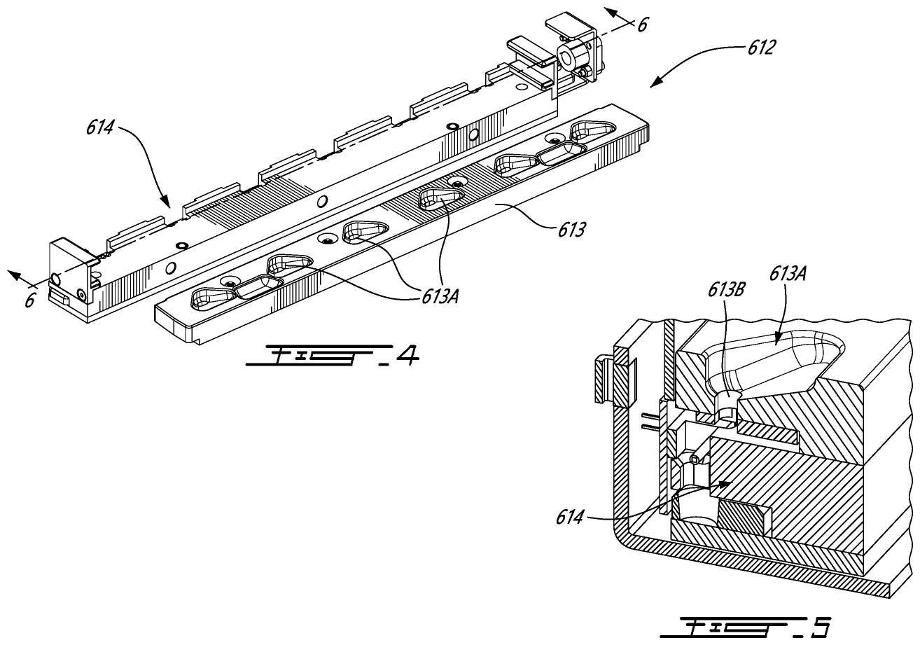

Referring now to FIGS. 8-9, the moving plate 616 is shown in a receiving position in FIG. 8 and in a delivering position in FIG. 9. In use, the moving plate 616 may be initially in the receiving position shown in FIG. 8. Pills P are inserted inside the hoppers 613A. The pills P then go through the hopper apertures 613B and are received within the guiding apertures 615A. In the receiving position, the guiding apertures 615A are in alignment with the moving plate apertures 616A. Consequently, the pills P may leave the guiding apertures 615A and may be received in to the moving plate apertures 616A. The pills P remain in the moving plate apertures 616A because an outlet of the moving plate apertures 616A are blocked by the distributing plate 617.

When delivering the pills P contained in the moving plate apertures 616A, the actuators 611 may be powered to move the moving plate 616, and thus the pills P located within the moving plate apertures 616A from the receiving position of FIG. 8 to the delivering position of FIG. 9. As shown in FIG. 9, once the moving plate 616 is in the delivering position, the moving plate apertures 616A are in alignment with the distributing apertures 617A and the pills P may leave the moving plate apertures 616A to go through the distributing apertures 617A via which the pills P may be loaded into the delivery mechanism 650, which will be described further below. The pills P may leave the distributing apertures 617A by moving along direction denoted by arrow A2 in FIG. 9. In the embodiment shown, the pills P are moved by gravity (dropped).

The moving plate 616, and the moving plate apertures 616A, may therefore by used as a holding location that holds the pills P after they have been inserted in the hoppers 613A, but before they are ready to be distributed into the delivery mechanism 650.

Referring more particularly to FIG. 6, to ensure proper alignment of the moving plate 616, the flange 611D may define a shoulder 611E that abuts the distributing plate 617 in the first position of the moving plate 616. Hence, the actuator 611 may be powered until the shoulder 611E abuts the distributing plate 617. The actuator 611 may sense that no further movement of the moving plate 616 is possible and power may be stopped. The controller 20 may control these aspects. The shoulder 611E may alternatively be defined by a protrusion of the moving plate 616.

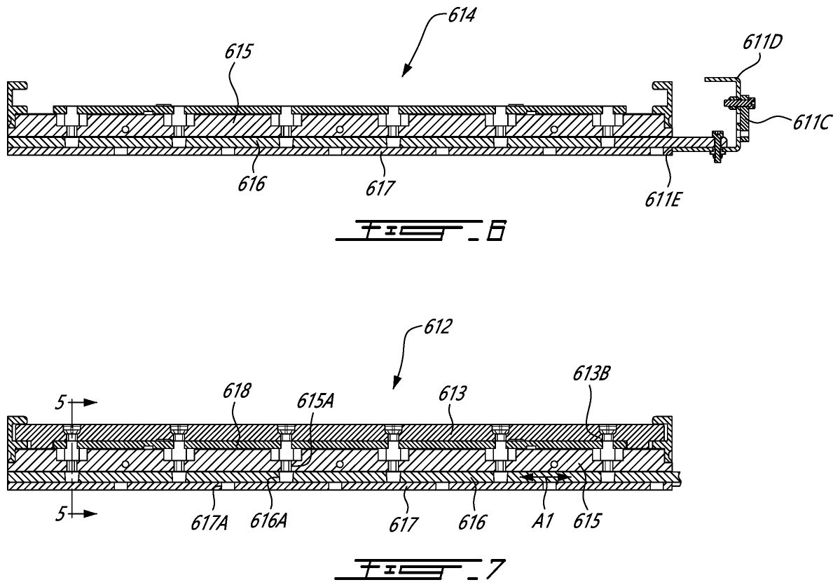

Referring now to FIG. 10, in another embodiment, the moving plate 616 may include secondary moving plate apertures 616B that are located adjacent the moving plate apertures 616A. The moving plate 616 may therefore be moved into a secondary receiving position, which is depicted in FIG. 10. Hence, in the receiving position, which can alternately be referred to herein as the primary receiving position, a first group of pills P can be delivered into the moving plate apertures 616A and, in the secondary receiving position, a second group of pills P′ can be delivered into the secondary moving plate apertures 616B. The moving plate 616 may have a delivering position (which can alternately be referred to as a primary delivering position) and a secondary delivering position. In the primary delivering position, the moving plate apertures 616A are in alignment with the delivering apertures 617A and, in the secondary delivering position, the secondary moving plate apertures 616B are in alignment with the delivering apertures 617A. Therefore, the dispensing mechanism 610 may hold a plurality of groups of pills P to be successively delivered to the delivery mechanism 650. This may reduce the burden of manual manipulations associated to keeping the dispensing mechanism 610 supplied with pills. It will be appreciated that the moving plate 616 may have more than two sets of moving plate apertures. For instance, the moving plate 616 may have tertiary moving plate apertures and so on.

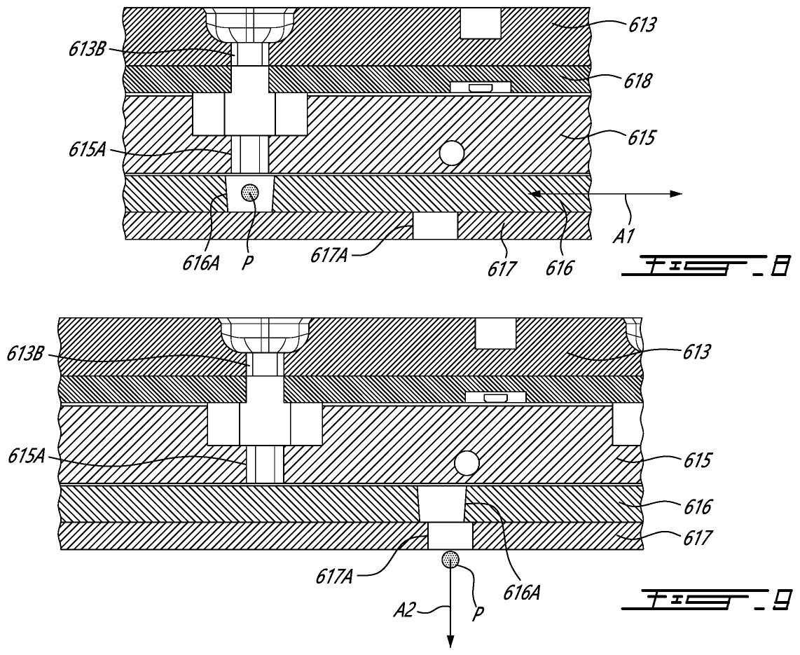

Referring now to FIGS. 11-12, in another embodiment, the moving plate 616 may include rotating dispensers 616C each having a plurality of apertures 616D circumferentially distributed about a rotation axis of the rotating dispenser 616C. The rotating dispensers 616C may be rollingly engaged to a remainder of the moving plate 616. In use, the moving plate 616 may be moved in the receiving position until one of the plurality of apertures 616D of each of the rotating dispensers 616C is in alignment with a respective one of the guiding apertures 615A. At which point, the rotating dispenser 616C may be rotated such that each of the plurality of apertures becomes in alignment with the guiding apertures 615A and receives pills P therein. Once the four apertures 616D of the rotating dispenser 616C are full with pills P, the moving plate 616 may be moved in the delivering position. At which point, the rotating dispenser 616C may be rotated along direction denoted by arrow A3 to successively bring each of the apertures 616D of the rotating dispenser 616C in alignment with the delivering apertures 617A to empty the pills P contained in the apertures 616D. It will be appreciated that the rotating dispenser 616C may include any number of apertures 616D, such as two, three, four, more than four and so on. Any suitable mechanism may be used to rotate the rotating dispenser 616C.

Referring back to FIGS. 2-3, the delivery mechanism 650 is now described in greater detail. The delivery mechanism 650 includes a carrier 651 that is movable along the longitudinal members 604 of the frame 601 between the front end 602 and the rear end 603 of the frame 601. The carrier 651 receives the pills P from the dispensing mechanism 610 and brings the pills towards the pill delivery paths 115 and drops the pills P inside the chimneys.

In the embodiment shown, the carrier 651 is engaged by two actuators 652 each mounted to a respective one of the two longitudinal members 604 of the frame 601. It will be appreciated that only one or more than two actuators may be used. The actuators 652 each include a motor 652A drivingly engaging a threaded shank 652B. The threaded shank 652B is threadingly engaged to a nut 652C (FIG. 2) secured to the carrier 651. Hence, powering the motors 652A of the actuators 652 induces rotation of the threaded shanks 652B that induces a movement of the nuts 652C, and of the carrier 651, in a front-back direction along the longitudinal members 604 of the frame 601. In other embodiments, the nuts may be replaced by threaded apertures defined through the carrier 651. The actuators may be any suitable actuator such as electric motors, solenoids, pneumatic actuators, hydraulic actuators, and so on. The controller 20 may be operatively connected to the actuators 652 to control a movement of the carrier 651.

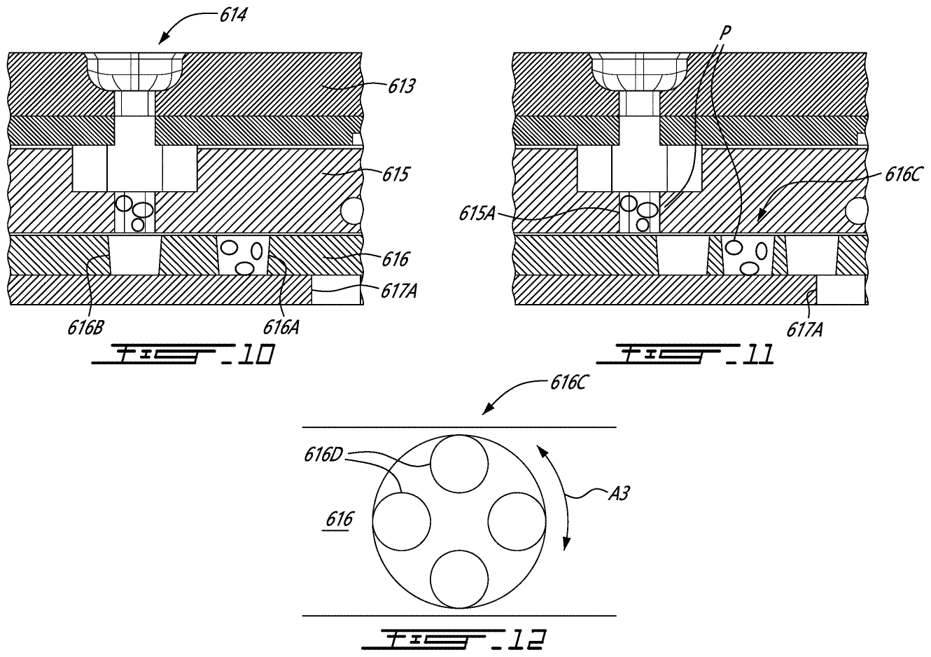

Referring now to FIG. 13, the carrier 651 is described in greater detail. The carrier 651 includes a carrier transverse member 653 that extends from one of the two longitudinal members 604 of the frame 601 to the other. Two flanges 654 are defined at opposite ends of the carrier transverse member 653. The two nuts 652C are secured to the two flanges 654 to be engaged by the threaded shanks 652B of the actuators 652. The carrier 651 is thus movable between the front and the rear of the frame 601 via actuation of the actuators 652 described herein above.

The carrier 651 further includes a carrier movable plate 655 mounted on the carrier transverse member 653. The carrier movable plate 655 defines apertures 655A that are sized for receiving the pills from the dispensing mechanism 610 described above. In the embodiment shown, a carrier intermediate plate 656 is disposed between the carrier movable plate 655 and the carrier transverse member 653. The carrier intermediate plate 656 may be made of a low friction material, such as Teflon™ to ease movements of the carrier movable plate 655 relative to the carrier transverse member 653. In some embodiments, this carrier intermediate plate 656 may be omitted.

As shown in FIG. 14, the carrier transverse member 653 defines first apertures 653A and second apertures 653B that are longitudinally offset from the first apertures 653A. The first and second apertures 653A, 653B are distributed along a length of the carrier transverse member 653, which extends substantially transversally to the direction of travel of the carrier 651. The first apertures 653A are used to deliver the pills P into the pill delivery paths 115 whereas the second apertures 653B are used to unload the pills P from the delivery system 600.

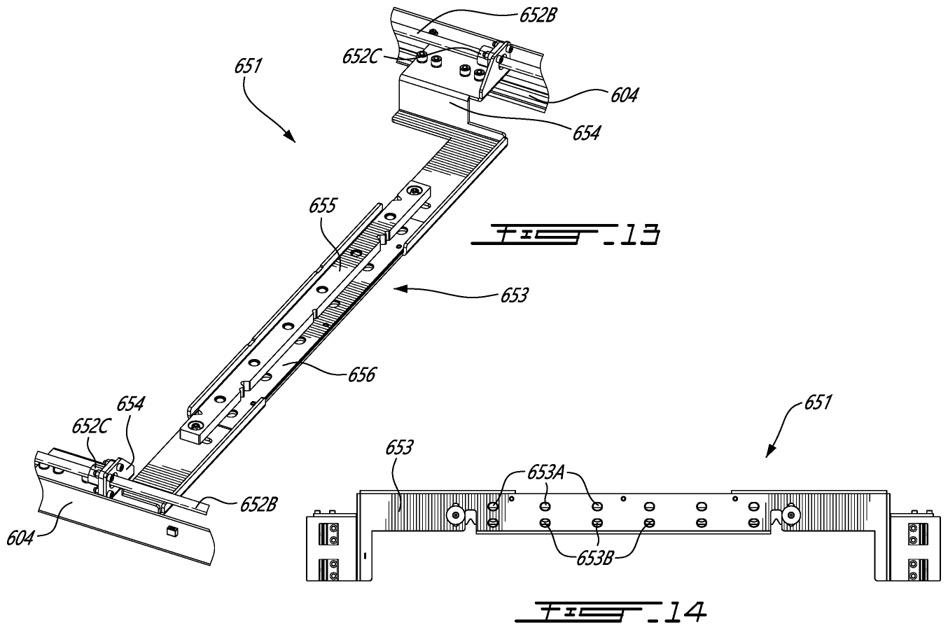

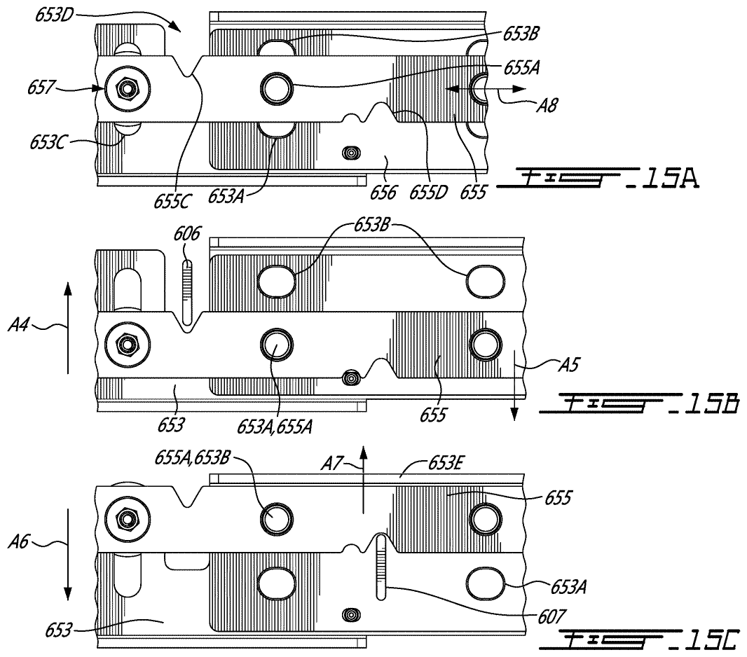

Referring now to FIGS. 15A to 15C, the carrier movable plate 655 is shown in three different positions relative to the carrier transverse member 653. In FIG. 15A, the carrier movable plate 655 is in a transport position in which the apertures 655A defined through the carrier movable plate 655 are located between the first and second apertures 653A, 653B of the carrier transverse member 653. In other words, in the transport position, the apertures 655A of the carrier movable plate 655 are offset from both of the first and second apertures 653A, 653B of the carrier transverse member 653. Thus, the pills contained within the apertures 655A of the carrier movable plate 655 remain contained by the carrier 651 during transport towards the pill delivery paths 115.

The carrier movable plate 655 is secured to the carrier transverse member 653 via fastening systems 657 described below. The fastening systems 657 are disposed at opposite ends of the carrier movable plate 655 and each include a fastener that extends through a fastener-receiving aperture 655B of the carrier movable plate 655 and through an elongated aperture 653C defined through the carrier transverse member 653. Any number and suitable locations of the fastening systems 657 are contemplated. The carrier movable plate 655 is therefore movable via the fasteners of the fastening systems riding into the elongated apertures 653C of the carrier transverse member 653. In another embodiment, the elongated apertures may be defined by the carrier movable plate 655 instead of by the carrier transverse member 653. Any other means permitting a sliding motion of the carrier movable plate 655 relative to the carrier transverse member 653 are contemplated. For instance, a rail system may be used. In another embodiment, a tab and groove system may be used and so on.

Referring now to FIG. 15B, the carrier 651 moves along direction denoted by arrow A4 towards the pill delivery paths 115 and towards the rear end of the frame 601 until tabs 606—two in the embodiment shown, but more may be used—of the frame 601 are received within notches 653D (FIG. 15A) defined by the carrier transverse member 653. It will be appreciated that only one or more than two tabs 606 and notches 653D may be used. The tabs 606 then abut the carrier movable plate 655 thereby pushing the carrier movable plate 655 relative to the carrier transverse member 653 along direction denoted by arrow A5. This movement of the carrier movable plate 655 brings the apertures 655A of the carrier movable plate 655 in alignment with the first apertures 653A of the carrier transverse member 653 thereby allowing the pills P to fall into the pill delivery paths 115. The position of the tabs 606 relative to a remainder of the frame 601 is selected to ensure that the first apertures 653A of the carrier transverse member 653 are in alignment with the pill delivery paths 115 once the tabs 606 contact an end of the notches 653D of the carrier transverse member 653.

Referring now to FIG. 15C, once the carrier 651 has delivered the pills P to the pill delivery paths 115, the carrier 651 is brought back towards the front end of the frame 601 along a direction denoted by arrow A6 until the carrier 651 at least partially overlaps the dispensing mechanism 610, which is described above. At which point, second tabs 607 of the frame 601 abut the carrier movable plate 655 to push the carrier movable plate 655 along a direction denoted by arrow A7. More or less than two second tabs 607 may be used. The actuators 652 may move the carrier 651 until the second tabs 607 have pushed the carrier movable plate 655 sufficiently to bring the apertures 655A of the carrier movable plate 655 between the first and second apertures 653A, 653B, or at least offset from both of the first and second apertures 653A, 653B, to bring the carrier movable plate 655 in the transport position depicted in FIG. 15A. At which point, pills may be dispensed via the dispensing mechanism 610 into the apertures 655A of the carrier movable plate 655. These pills will remain in those apertures 655A because they are blocked by the carrier transverse member 653.

In some cases, it may be desired to purge the carrier 651 from the pills P it contains. This situation may occur, for instance, if no more pills are required within the heating chamber 110. In such a case, the actuators 652 may further move the carrier 651 along the direction denoted by arrow A6 to further push the carrier movable plate 655 until the apertures 655A of the carrier movable plate 655 become in alignment with the second apertures 653B of the carrier transverse member 653. By further moving the carrier 651 as such, the second apertures 653B of the carrier transverse member 653 become aligned with a chute 608 (FIG. 2). The pills P may then be purged out of the carrier 651 by passing through the second apertures 653B of the carrier transverse member 653 and falling in the chute 608 where a user may retrieve them for future use.

The carrier transverse member 653 may define a flange 653E. The flange 653E may define a stopper such that when the carrier movable plate 655 is in abutment against the flange 653E of the carrier transverse member 653, the apertures 655A of the carrier movable plate 655 are in alignment with the second apertures 653B of the carrier transverse member 653.

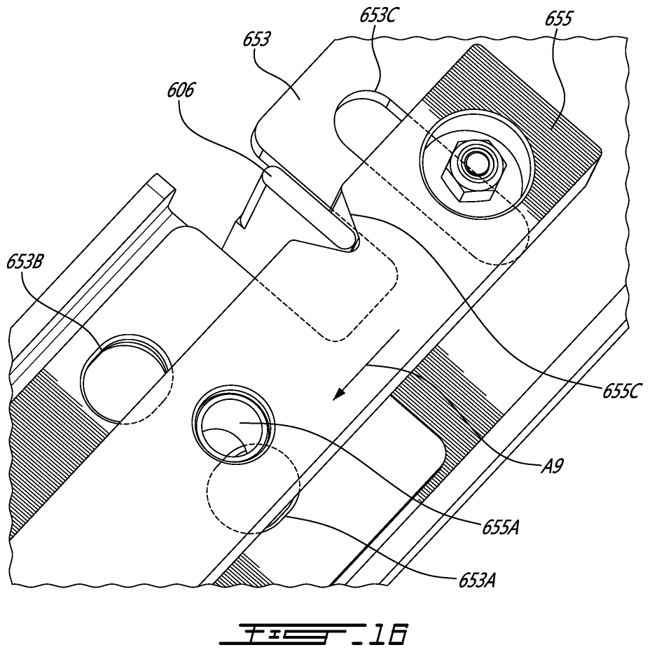

Referring now to FIGS. 15A and 16, in some cases, there may be a misalignment of the carrier movable plate 655 between the transport position depicted in FIG. 15A and the other positions depicted in FIGS. 15B and 15C. More specifically, in the transport position in FIG. 15A, the apertures 655A of the carrier movable plate 655 have to be in alignment with the distributing apertures 617A (FIG. 9) of the dispensing mechanism 610 in order to properly accept the pills P. Also, in the position depicted in FIG. 15B, the apertures 655A of the carrier movable plate 655 have to be in alignment with the first apertures 653A of the carrier transverse member 653, which themselves have to be in alignment with the pill delivery paths 115. In some cases, assembly tolerances, manufacturing tolerances, and so on can misalign the different components impeding proper alignment of the different apertures.

To at least partially alleviate this misalignment, V-notches in the carrier movable plate 655 are used. In the embodiment shown, the carrier movable plate 655 is movable transversally along direction denoted by arrow A8 relative to the carrier transverse member 653. The carrier movable plate 655 includes herein a rearward-facing V-notch 655C and a forward-facing V-notch 655D. Each of those V-notches 655C, 655C is engageable by a respective one of the tabs 606 and second tabs 607. Any suitable number of V-notches 655C, 655D is contemplated.

As shown in FIG. 16, the apertures 655A of the carrier movable plate 655b are slightly offset from both of the first and second apertures 653A, 653B of the carrier transverse member 653. The delivery system 600 of the present embodiment includes a self-centering system that includes the tabs 606, the second tabs 607, the rearward-facing V-notches 655C and the forward-facing V-notches 655D. The operation of the self-centering system is described below using the tabs 606 and the rearward-facing V-notches 655C, but the principles are the same for the forward-facing V-notches 655D and the second tabs 607.

As illustrated, if a transverse or lateral misalignment is provided between the different apertures, the tabs 606 will engage the rearward-facing V-notches 655C. Those V-notches define faces that converge toward one another. Hence, if a lateral misalignment is present, the tabs 606 will ride against one of those faces thereby pushing on those faces. This will induce a lateral movement of the carrier movable plate 655 along direction denoted by arrow A9 to laterally or transversally align the apertures 655A of the carrier movable plate 655 with the first apertures 653A of the carrier transverse members 653. Hence, a compound movement along two transverse directions is imparted on the carrier movable plate 655 to bring the different apertures in proper alignment with one another.

To further help in alleviating such misalignment, the first and second apertures 653A, 653B of the carrier transverse member 653 may be elongated in the transverse direction, which is perpendicular to a direction of travel of the carrier 651. Similarly, the elongated apertures 653C of the carrier transverse member 653 may be wider than a diameter of a fastener extending therethrough to allow this lateral movement along arrows A9. The same phenomenon occurs with the forward-facing V-notches 655B and the second tabs 607. Except that, this time, the movement is in a direction opposite that represented by arrow A9.

The disclosed self-centering system may therefore compensate for manufacturing or other tolerances that would otherwise impede the proper dropping of the pills P into the pill delivery paths 115 or impede the reception of the pills P from the dispensing mechanism 610.

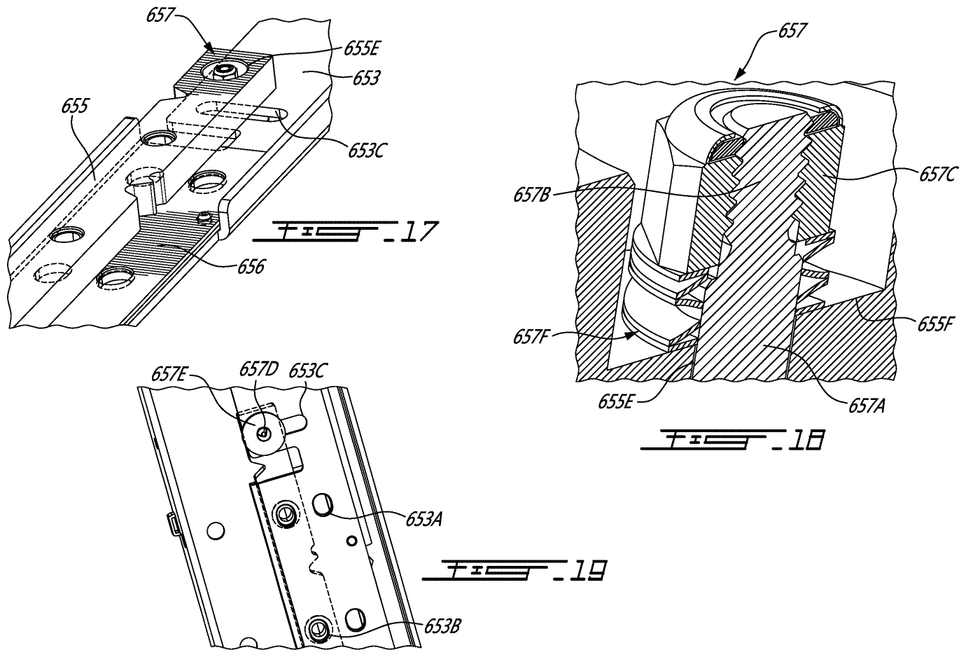

Referring now to FIGS. 17 to 19, the fastening system 657 is now described. The fastening system 657 includes a fastener 657A having a threaded shank 657B threadingly engaged by a nut 657C. The fastener 657A extends through an aperture 655E defined through the carrier movable plate 655. The fastener 657A includes a head 657D. A washer 657E is disposed between the head 657D of the fastener 657A and the carrier transverse member 653. The washer 657E may be made of a low-friction material, such as Teflon™, to facilitate movements of the carrier movable plate 655 relative to the carrier transverse member 653.

A biasing member 657F, embodied herein as a Belleville washer, is disposed between the nut 657C and a shoulder 655F defined by a change of diameter within the aperture 655E of the carrier movable plate 655. The biasing member 657F may alternatively be a spring, a rubber gasket, or any other suitable means to exert a force against compression.

In use, the biasing members 657F are used are used to bias the carrier movable plate 655 against the carrier transverse member 653. This force may be seen as a compression force exerted against the carrier intermediate plate 656. This force is selected to allow a movement of the carrier movable plate 655, but to limit free movements of said carrier movable plate 655. In other words, this force is sufficient to prevent the movement of the carrier movable plate 655 when the carrier 651 moves toward either the front or rear end of the frame 601, but permits the movement of the carrier movable plate 655 when it is engaged by the tabs 606 and second tabs 607. This may provide stability to the system and minimize wobbling.

The disclosed delivery system 600 including the dispensing mechanism 610 and the delivery mechanism 650 may be used to safely and efficiently deliver pills into the heating chamber 110 of the fusion system 10.

A method of operating the delivery system 600 is also disclosed. The method includes: receiving pills to be distributed into the pill delivery paths 115; moving the pills from a first position in which the pills and the pill delivery paths 115 are offset from one another to a second position in which the pills and the pill delivery paths are adjacent to each other; and distributing the pills into the pill delivery paths 115.

The receiving of the pills includes receiving the pills within moving plate apertures of a moving plate.

The method may include moving the moving plate and the pills located within the moving plate apertures 616A from a receiving position in which the moving plate apertures 616A are offset from distributing apertures 617A of the distributing plate 617 to a distributing position in which the moving plate apertures 616A are aligned with the distributing apertures 617A and in which the pills move from the moving plate apertures 616A to the distributing apertures 617A.

The pills may be received into the carrier 651 from the distributing apertures 617A. The pills may be guided into the moving plate apertures 614A with the hopper apertures 613B of the hopper plate 613.

The moving of the pills from the first position to the second position may include moving the carrier 651 containing the pills from the first position to the second position. The method may include moving the carrier movable plate 655 relative to the carrier 651 from a first relative position in which first apertures 653A are offset from apertures 655A of the carrier movable plate 655 and a second relative position in which the first apertures 653A are in alignment with the apertures 655A of the carrier movable plate 655.

The moving of the carrier from the first positing to the second position may include abutting the carrier movable plate 655 against a tab to move the carrier movable plate 655 relative to the carrier 651 until the first apertures 653A are aligned with the apertures 655A.

Depending on the embodiment, one or more detection means can be provided to automatically validate the position of, or the presence or absence of, a given element of the system or sample. The detection means can be selected as a function of the specific embodiment based on the knowledge of persons having ordinary skill in the art and can, for example, include one or more of a proximity sensor, a camera, a video camera, a weight sensor, or any other suitable type of sensor. For example, a sensor can be used to determine the presence or absence of containers in the sample support (e.g. confirming that any required moulds are indeed present prior to commencing the fusion process), confirming the presence or absence of a sample inside containers, confirming that the handling mechanism has been withdrawn from the fusion area prior to closing the door, confirming that the handling mechanism is aligned with the agitation mechanism prior to lowering, confirming that pills are present in the distribution mechanism, confirming that pills have been dropped, etc. Via a user interface, partially automated confirmation procedures involving user response may also be implemented. For instance, the controller may prompt, at the user interface, the user to confirm that an element of the system or samples are at a given position, present, or absent, at any suitable point of the fusion process, and proceed to the next step of the fusion process contingent upon receiving, from the user interface, the requested confirmation from the user.

The embodiments described in this document provide non-limiting examples of possible implementations of the present technology. Upon review of the present disclosure, a person of ordinary skill in the art will recognize that changes may be made to the embodiments described herein without departing from the scope of the present technology. Yet further modifications could be implemented by a person of ordinary skill in the art in view of the present disclosure, which modifications would be within the scope of the present technology.

1. A method of operating a delivery system for a fusion system having a fusion area and pill delivery paths in communication with the fusion area, the method comprising:
with a delivery mechanism, at a first position, receiving pills to be distributed, the first position forwardly offset from the pill delivery paths;
moving the delivery mechanism rearwardly from the first position to a second position, the second position above the pill delivery paths; and
with the delivery mechanism, at the second position, dropping the pills into the fusion area along the pill delivery paths.

2. The method of claim 1, further comprising, prior to said moving, receiving the pills into a carrier of the pill delivery mechanism at the first position, wherein the moving includes moving the carrier from the first position to the second position.

3. The method of claim 2, wherein the carrier defines first apertures, the method comprising moving a carrier movable plate relative to the carrier from a first relative position in which the first apertures of the carrier are offset from apertures of the carrier movable plate and a second relative position in which the first apertures are in alignment with the apertures of the carrier movable plate.

4. The method of claim 3, wherein the moving of the carrier from the first position to the second position includes abutting the carrier movable plate against a tab to move the carrier movable plate relative to the carrier until the first apertures are aligned with the apertures of the carrier movable plate.

5. The method of claim 3, wherein said receiving the pills includes receiving the pills in the apertures of the carrier movable plate.

6. The method of claim 2, further comprising delivering the pills into the carrier, including receiving the pills within moving plate apertures of a moving plate.

7. The method of claim 6 further comprising moving the moving plate and the pills located within the moving plate apertures from a receiving position in which the moving plate apertures are offset from distributing apertures of a distributing plate to a distributing position in which the moving plate apertures are aligned with the distributing apertures and in which the pills move from the moving plate apertures through the distributing apertures into the apertures of the carrier movable plate.

8. The method of claim 6, further comprising guiding the pills into the moving plate apertures with a hopper plate having hopper apertures.

9. The method of claim 8 further comprising a user positioning the pills into the hopper apertures.

10. A delivery system for a fusion system having a fusion area and pill delivery paths leading to the fusion area, the delivery system comprising:
a frame;
a dispensing mechanism mounted to the frame, the dispensing mechanism operable to receive pills and to distribute the pills; and
a delivery mechanism movable between a first position in which the delivery mechanism is adjacent the dispensing mechanism for receiving the pills from the dispensing mechanism and a second position in which the delivery mechanism is adjacent the pill delivery paths to deliver the pills to the pill delivery paths.

11. The delivery system of claim 10, wherein the dispensing mechanism includes:
a hopper plate defining hopper apertures;
a moving plate defining moving plate apertures; and
a distributing plate defining distributing apertures, wherein the hopper apertures are offset from the distributing apertures, the moving plate moving between a receiving position in which the moving plate apertures are in alignment with the hopper apertures and a dispensing position in which the moving plate apertures are in alignment with the distributing apertures.

12. The delivery system of claim 10, comprising an actuator engaged to the moving plate to move the moving plate between the receiving position and the dispensing position, the actuator drivingly engaged to a threaded shank threadingly engaged to a nut secured to the moving plate.

13. The delivery system of claim 10, wherein the delivery mechanism includes:
a carrier moving relative to the frame, the carrier defining first apertures;
an actuator engaged to the carrier and the frame, the actuator operable to move the carrier between the first and second positions; and
a carrier movable plate defining apertures,
wherein the carrier movable plate is movable relative to the carrier between a first relative position in which the first apertures are offset from the apertures of the carrier movable plate and a second relative position in which the first apertures are in alignment with the apertures of the carrier movable plate.

14. The delivery system of claim 13, wherein the carrier defines second apertures, the carrier movable plate movable relative to the carrier into a third relative position in which the second apertures are in alignment with the apertures of the carrier movable plate.

15. The system of claim 13, comprising a first tab secured to the frame, the first tab in abutment against the carrier movable plate to move the carrier movable plate from the first relative position to the second relative position when the delivery mechanism is in the second position.

16. The system of claim 15, wherein the carrier movable plate defines a V-notch, the first tab received within the V-notch for aligning the carrier movable plate in the second position of the delivery mechanism, the carrier movable plate movable transversally relative to a direction of travel of the carrier between the first and second positions.

17. The system of claim 15, comprising a second tab secured to the frame, the second tab in abutment against the carrier movable plate to move the carrier movable plate from the second relative position to the first relative position when the delivery mechanism is in the first position.

18. A dispensing mechanism for a delivery system of a fusion system, comprising:
a hopper plate defining hopper apertures;
a moving plate defining moving plate apertures; and
a distributing plate defining distributing apertures,
wherein the hopper apertures are offset from the distributing apertures, the moving plate moving between a receiving position in which the moving plate apertures are in alignment with the hopper apertures and a dispensing position in which the moving plate apertures are in alignment with the distributing apertures.

19. The dispensing mechanism of claim 18, comprising an actuator engaged to the moving plate to move the moving plate between the receiving position and the dispensing position.

20.-31. (canceled)
